(19) United States
(12) Patent Application Publication
(10) Pub. No.: US 2010/0005387 A1
(43) Pub. Date: Jan. 7, 2010

(54) Terminal, content display method, and content display program

(75) Inventor: Hiroyuki Toki, Sunnyvale, CA (US)

Correspondence Address: MORRISON & FOERSTER LLP, 425 MARKET STREET, SAN FRANCISCO, CA, 94105-2482, US

(73) Assignee: Access Co., Ltd., Chiyoda-ku, Tokyo (JP)

(21) Appl. No.: 12/311,591

(22) PCT Filed: Oct. 4, 2007
(86) PCT No.: PCT/JP2007/069462

§ 371 Date: Apr. 3, 2009

(30) Foreign Application Priority Data
Oct. 5, 2006 (JP) 2006-273733

(51) Int. Cl. G06F 17/00; G06F 3/048

(52) U.S. Cl. 715/246; 715/788

(57) ABSTRACT

A terminal device adapted to display content, comprising a display; a content display means for analyzing data of the content, and rendering and displaying the content on the display based on a result of analyzing; an area designation means for designating an area in the content displayed on the display; an element extraction means for extracting an element which forms the content and at least a part of which is included in the designated area; and a content enlarging and displaying means for enlarging the extracted element relative to a size defined when the area is designated and for displaying the extracted element on the display.

### TECHNICAL FIELD

The present invention relates a terminal device, a content display method and a content display program for displaying content.

### BACKGROUND OF THE INVENTION

Recently, with the rapid dispersion of networks (e.g., the Internet) and the development of related technology, users have become able to browse content on a network with various types of information terminals, such as a home appliance, a car navigation as well as desktop type and laptop type PCs (Personal Computers). On these information devices, information browsing software (hereafter, referred to as a “browser”) is installed. The browser is able to analyze a document (hereafter, referred to as an “HTML document”) described in a markup language, such as an HTML, and executes a layout process for elements forming the document based on the result of analyzing. Consequently, the information (e.g., a page) on the Internet is rendered and is displayed on the terminal device.

In this specification, the meaning of “page” is defined below. “page”: The page means a set of data readable on an information terminal, such as a PC, obtained via a network, and is the whole content that is to be displayed when the user designated a particular URI (Uniform Resource Identifier). In other words, the term “page” means the whole content that can be displayed by scrolling the image on a display. The term “page” includes a page to be browsed offline as well as a page to be browsed online. The page to be browsed offline includes, for example, a page downloaded through the network and cached by the browser, or a page stored in a local folder of the terminal in an mht format. The page includes an HTML document and various types of data, such as image data and sound data. It should be noted that “page” can be expressed as “content”.

The screen size of a portable terminal, such as a mobile phone, is extremely smaller than that of a PC. Therefore, the displayed size of the page on the screen of the portable terminal is small and visibility of the display is low. In particular, when a page intended for browsing on a desktop PC is displayed on the mobile phone, the page is displayed in a considerably reduced size. Therefore, the low visibility becomes more noticeable, which results in inconvenience for users.

For example, U.S. Pat. No. 5,754,348 (hereafter, referred to as “patent document”) discloses a technology made in consideration of such a problem. According to the patent document, when a desired area on the screen is designated through a user operation, an enlarged image of the area is displayed on a separate window. Since the image on the separate window is enlarged, the degree of visibility is increased. That is, according to the display method in the patent document, the user is able to brows the desired area in the page in a high degree of visibility.

### DISCLOSURE OF THE INVENTION

According to the patent document, when the user wants to enlarge a desired sentence in a page, the user is required to conduct a user operation for designate an enlargement target so that the entire sentence is included on the designated area. However, to conduct an operation for designating an area to include the entire of the desired sentence on a screen having a low degree of visibility is inconvenience for users. It becomes possible to include securely the entire desired sentence in the designated area by widely designating the area; however, in this case although the operation for designating the area becomes easier, text which the user is not interested in is also displayed on the separate window. By thus widely designating the area to be enlarged, the enlarging rate decreases, and thereby the display size of the desired sentence also decreases. For this reason, the user may become unable to browse the desired sentence in a high degree of visibility, and therefore it is not desirable to designate a wide area. A similar problem may also occur in regard to images (images placed on a page) in addition to the problem regarding the text.

Therefore, in consideration of the above described problem, the object of the invention is to provide a terminal, a content display method, and a content display program capable of enlarging only an element, such as text and an image, desired by a user through a simple operation.

According to an embodiment of the invention, there is provided a terminal device adapted to display content, comprising: a display; a content display means for analyzing data of the content, and rendering and displaying the content on the display based on a result of analyzing; an area designation means for designating an area in the content displayed on the display; an element extraction means for extracting an element which forms the content and at least a part of which is included in the designated area; and a content enlarging and displaying means for enlarging the extracted element relative to a size defined when the area is designated and for displaying the extracted element on the display. The content enlarging and display means may render the extracted element again and display the extracted element on the display.

According to the terminal device configured as described above, by designating text and etc. which a user is interested in while surrounding a part of the text and etc., the user is able to enlarge the entire extracted text, display the enlarged text on the display, and browse the displayed text. That is, the user does not need to perform a precise operation to include only a desired part in the content, and the user becomes able to enlarge and display the part through the above describe simple operation and thereby to browse the part of the content.

In this case, the element is identified on a basis of a predetermined character string or code. The predetermined character string or code may include at least one of a tag of a markup language and a punctuation or a control code. The control code may include at least one of a page break, a linefeed or a tab. Preferably, the predetermined character string and code for identifying an element may be settable by the user.

With this configuration, it becomes possible to designate relatively short text, such as one paragraph, one sentence and one clause, not the entire long text, and to enlarge and display the designated relatively short text. Consequently, visibility in an enlarged view can be enhanced.

The terminal device may further include an operation means for accepting an input operation by a user, and a designated area setting means for setting a position of the area designated by the area designation means in accordance with the input operation. The terminal device may further include a designated area size setting means for setting a size of the area designated by the area designation means in accordance with the input operation.

The terminal device may further include a captured image creation means for creating a captured image of the content, and a position relationship information creation means for creating position relationship information for associating a position of the captured image with a position of the content. In this case, the content display means may display the content on the display by displaying the captured image of the content, and the area designation means may designate an area in the captured image of the content displayed on the display to designate the area of the content corresponding to the designated area of the captured image based on the position relationship information.

The content display means may highlight and display the area designated by the area designation means.

The element extraction means may execute extraction of an element, further based on a predetermined rule, from elements at least a part of each of which is included in the designated area of the content.

The terminal device may include two displays. In this case, the content display means may display the content on one of the two displays, and the content enlarging and displaying means may display the element extracted by the element extraction unit on the other of the two displays such that the extracted element is enlarged relative to the one of the two displays.

According to an embodiment of the invention, there is provided a content display method for displaying content on a display, comprising: a content display step of analyzing data of the content, and rendering and displaying the content on the display based on a result of analyzing; an area designation step of designating an area in the content displayed on the display; an element extraction step of extracting an element which forms the content and at least a part of which is included in the designated area; and an enlarging and displaying step of enlarging the extracted element relative to a size defined when the area is designated and displaying the extracted element on the display. The content enlarging and display step may render the extracted element again and display the extracted element on the display.

By employing the content display method, when the user designates text and etc. which a user is interested in while surrounding a part of the text and etc., the user becomes able to enlarge the entire extracted text, display the enlarged text on the display, and browse the displayed text. That is, the user does not need to perform a precise operation to include only a desired part in the content, and the user becomes able to enlarge and display the part through the above describe simple operation and thereby to browse the part of the content.

In the above described content display method, the element is identified on a basis of a predetermined character string or code. The predetermined character string or code may include at least one of a tag of a markup language and a punctuation or a control code. The control code may include at least one of a page break, a linefeed or a tab. Preferably, the predetermined character string and code for identifying an element may be settable by the user.

With this configuration, it becomes possible to designate relatively short text, such as one paragraph, one sentence and one clause, not the entire long text, and to enlarge and display the designated relatively short text. Consequently, visibility in an enlarged view can be enhanced.

The content display method may further include an operation step of accepting an input operation by a user, and a designated area setting step of setting a position of the area designated in the area designation step in accordance with the input operation. The content display method may further include a designated area size setting step of setting a size of the area designated in the area designation step in accordance with the input operation.

The content display method may further include a captured image creation step of creating a captured image of the content; and a position relationship information creation step of creating position relationship information for associating a position of the captured image with a position of the content. The content display step may display the content on the display by displaying the captured image of the content, and the area designation step may designate an area in the captured image of the content displayed on the display to designate the area of the content corresponding to the designated area of the captured image based on the position relationship information.

In the content display method, the content display step may highlight and display the area designated in the area designation step.

The element extraction step may execute extraction of an element, further based on a predetermined rule, from elements at least a part of each of which is included in the designated area of the content.

According to an embodiment of the invention, a content display program and a computer-readable medium storing the content display program for causing a computer to execute the above described content display method is provided.

According to the embodiment, a terminal device, a content display method and a content display program capable of enlarging and displaying only an element, such as text or an image desired by the user with a simple operation can be provided.

### BRIEF DESCRIPTION OF THE DRAWINGS

FIG. 1 illustrates an outer appearance of a terminal device according to an embodiment of the invention.

FIG. 2 is a block diagram illustrating a configuration of the terminal device according to the embodiment of the invention.

FIG. 3 illustrates a functional block diagram of a browser engine included in a browser according to the embodiment of the invention.

FIG. 4 is a flowchart illustrating a simple view mode display process executed by the browser according to the embodiment of the invention.

FIG. 5 illustrates an example of a screen displayed by the browser according to the embodiment of the invention.

FIG. 6 illustrates an example of a screen displayed by the browser according to the embodiment of the invention.

### BEST MODE FOR CARRYING OUT THE INVENTION

In the following, an embodiment according to the present invention is described with reference to the accompanying drawings.

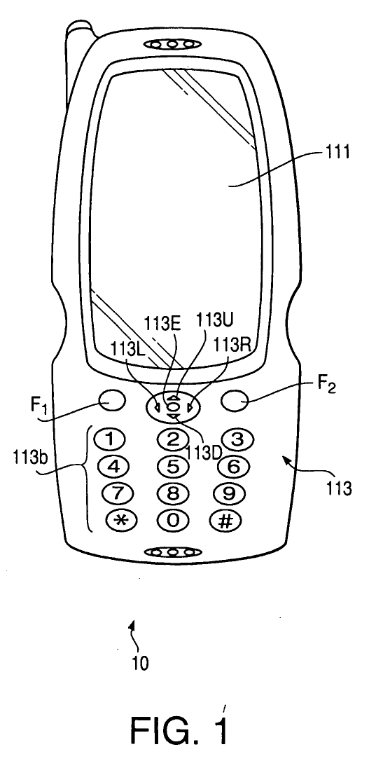

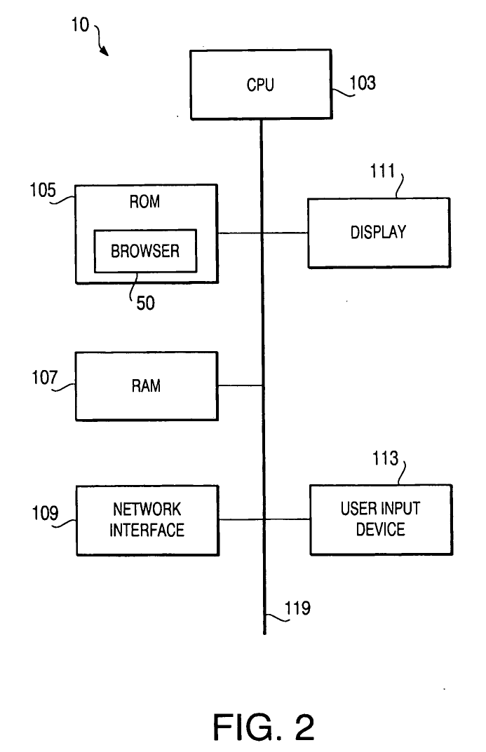

FIG. 1 illustrates an outer appearance of a terminal device 10 according to an embodiment of the invention. FIG. 2 is a block diagram illustrating a configuration of the terminal device 10 according to the embodiment of the invention. Although the terminal device 10 according to the embodiment of the invention is a mobile phone, variations in which the invention is applied to a PC (e.g., a desktop PC or a laptop PC), PDA, PHS (Personal Handy phone System), a portable game device, or a home appliance are also included within the scope of the invention.

As shown in FIG. 2, the terminal device 10 includes a CPU 103 which controls totally the entire terminal device. To the CPU 103, various components are connected via a bus 119. The CPU 103 achieves various functions through communication with other components via the bus 119. These components include a ROM (Read-Only Memory) 105, a RAM (Random-Access Memory) 107, a network interface 109, a display 111, a user input device 113. The bus 119 includes a power supply line as well as data lines. To the components including the CPU 103, power is supplied via the power supply line from a battery (not shown).

The ROM 105 stores various types of programs and data. The program stored in the ROM 105 includes, for example, a browser 50. The browser 50 is information browsing software for browsing content described in a predetermined markup language online or offline. The browser 50 supports not only a Web page intended for mobile devices described, for example, in a compact HTML, but also a page intended for PCs.

On the RAM 107, various types of programs stored, for example, in the ROM 105 is loaded. The program (e.g., the browser 50) stored in the ROM 105 is read in accordance with a user operation through the user input device 113 (hereafter, simply referred to as a “user operation”), and is loaded in a predetermined area in the RAM 107. Thus, the browser 50 is started, and the user is allowed to perform Web browsing (i.e., the user becomes able to browse Web contents).

The terminal device 10 is provided with, as the user input device 113, a 5-way key 113a, function keys F1 and F2, and a ten-key 113b. The 5-way key 113a includes four direction keys (113U, 113D, 113R, and 113L), and an enter key 113E. When a user presses an operation key, a signal corresponding to the pressed key is inputted to the CPU 103 in the terminal device 10. By executing a process corresponding to the inputted signal by the CPU 103, various functions including Web browsing is achieved on the terminal device 10. The user is able to scroll a screen of a Web page being browsed by operating either of the 5-way key 113a or the ten-key 113b.

It should be noted that the user input device 113 does not need to be a mechanical key, such as the 5-way key 113a or the ten-key 113b, and may be implemented by keys of the type, such as a membrane key or a touch panel.

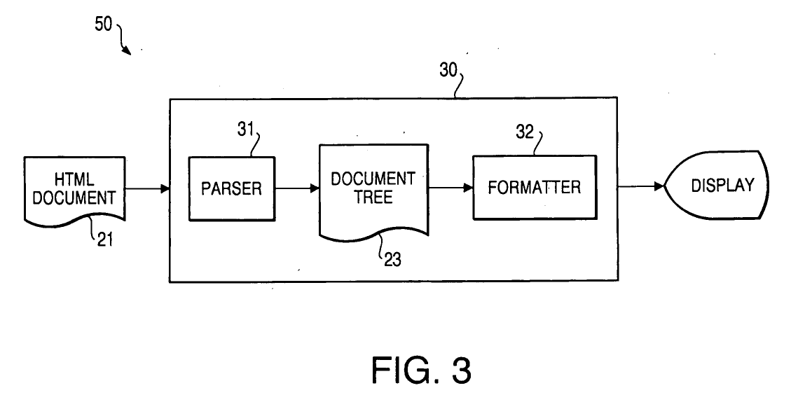

Hereafter, the function of the browser 50 is explained. First, a browser engine 30 which is a principal component of the browser 50 is explained with reference to FIG. 3.

FIG. 3 is a functional block diagram of the browser engine 30 included in the browser 50. As shown in FIG. 3, the browser engine 30 includes function blocks, such as a parser 31 and a formatter 32.

When an URL is inputted through the user operation (or when a URL is designated by selecting an anchor contained in a Web page displayed on the display 111, or when a URL saved as a bookmark or a history in the terminal device 10 is selected), a request message complying with an HTTP (Hypertext Transfer Protocol) for requesting resources such as a Web page is created, and is transmitted to a server corresponding to the inputted URL on a network. Then, a response message corresponding to the request message is created by the server, and is returned to the browser 50. The response message reaches the browser 50 via the network, and is passed to the parser 31. It should be noted that the response message is formed such that an HTML document 21 designated by the URL is contained in a message body. In this description, the HTML document 21 is a document describing a logical structure of a page WP intended for PCs.

The parser 31 analyzes the HTML document 21, and creates a document tree 23 describing the logical structure (i.e., relationships between elements forming the page described by the HTML document 21) of the HTML document. It should be noted that the document tree 23 only expresses the logical structure of the HTML document 21, and does not include information concerning expression of the document.

Next, the formatter 32 executes formatting based on information, such as the document tree 23, tags and a style sheet, and calculates a layout of the elements to be displayed on the display 111. The formatting executed by the formatter 33 is a characteristic process of the browser 50 (which is explained later). Then, the formatter 33 executes rendering based on the determined layout, and creates drawing data. Next, the created drawing data is loaded, for example, in a video memory area in the RAM 107. Through the above described process, the HTML document 21, i.e., the requested web page, is displayed on the display 111. In the following, the term “element” means a set of information, such as text or an image specified based on a certain character string or code, such as a tag in the mark-up language. In addition to an element defined by a tag in a markup language, a clause, a sentence or a paragraph delimited by codes, such as punctuations, or control codes, such as linefeeds, are also included in the “element”. Although the definition of the “element” (i.e., setting of a character string or a code to be used as a delimiter for an element) has been set in the browser in advance, the user is also able to change the definition.

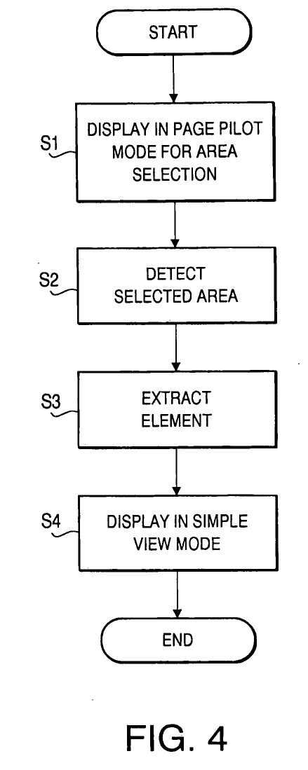

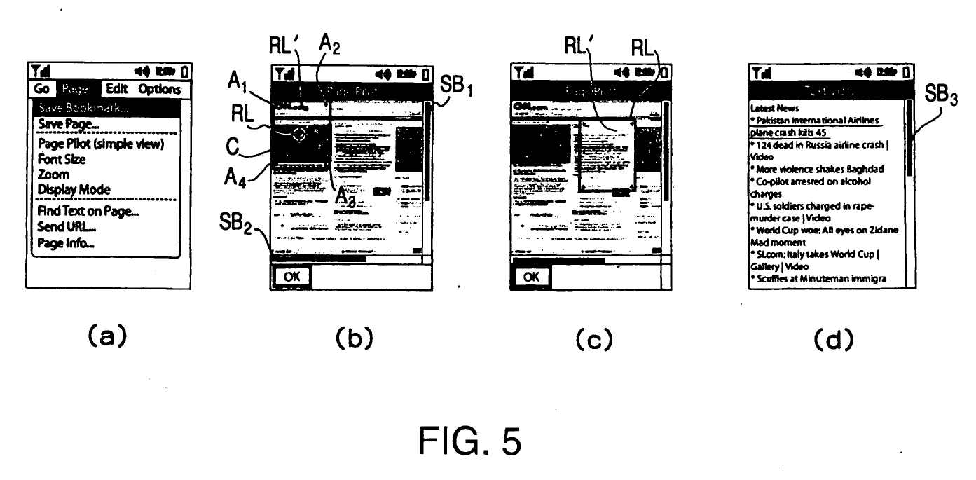

Next, a simple view mode display according to the embodiment of the invention is explained with reference to FIGS. 4 and 5(a) to 5(d). FIG. 4 is a flowchart illustrating a simple view mode display process executed by the browser according to the embodiment of the invention. FIGS. 5(a) to 5(d) illustrate an example of the screen displayed by the browser 50 in the simple view mode display process according to the embodiment of the invention.

First, when “Page Pilot (simple view)” in a “Page” menu is selected through the user operation (see FIG. 5(a)) in a state where the page is displayed on the display 111 of the browser 50, the browser 50 starts the simple view mode display process in response to the user operation as a trigger. Then, the display mode moves to a page pilot mode (step S1; hereafter, “step” is abbreviated as “S” in the description and drawings). Consequently, as shown in FIG. 5(b), the page is displayed on the browser 50 in the page pilot mode.

The page displayed according to the embodiment has been created on the assumption that the page is browsed on a standard display of a desktop PC, such as a QVGA (Quarter Video Graphics Array). By contrast, the display 111 has a small screen size, such as QVGA (Quarter Video Graphics Array). However, the formatter 32 according to the embodiment does not execute the formatting in accordance with the pixel number of the display 111 (e.g., returning of letters in accordance with the pixel number in the screen width direction). Therefore, as shown in FIGS. 5(a) to 5(d), the page is not accommodated in the display area of the display 111, and only a part of the page is displayed. The user is able to browse the entire page by scrolling the page while operating scroll bars SB₁ and SB₂.

Two ways of displaying forms of a page are provided in the page pilot mode. One is a normal display form. The normal display form means a display form in which page data described in a markup language, such as an HTML document, is rendered and is displayed on the display 111. The other is a capturing display form. The capturing display form means a display form in which a page which has been rendered once is captured and is stored, for example, in an internal memory of the CPU 103 (or in the RAM 107), and the captured image is displayed on the display 111.

In the former case, i.e., the normal display mode, anchor links and etc. are included in the page. Therefore, in this case, advantages that the user is able to access a linked destination by only designating an anchor link through the user operation are achieved. In the latter case, i.e., the capturing display mode, the browser 50 refers to the internal memory of the CPU 103 to read the captured image, and displays the captured image on the display 111. Therefore, in this case, the process such as analyzing is not required because in this case only the page already rendered is displayed again. Therefore, the load on the CPU 103 can be reduced, and the advantages that the drawing speed increases can be achieved. When the entire page having an XGA size is displayed to be accommodated in the screen, the HTML document is analyzed again to create data for reduced display, and the data for the reduced display is displayed on the display 111. By contrast, in the capturing display form, the CPU 103 is only required to read the captured image and present the reduced display in accordance with the display 111, and therefore the load on the CPU 103 can be reduced. In the page pilot mode according to the embodiment, the page is displayed principally for the purpose of designating a desired area in the page by the user as described later. Therefore, the advantages that the load on the CPU 103 can be reduced are highly evaluated in comparison with the advantages that anchor links are contained in the page. With regard to settings as to which of the display modes is used for displaying of the page, it is possible to make such settings desirably, for example, through the user operation. Furthermore, the settings may be made in advance considering the performance of the terminal device 10.

In the page pilot mode, a rectangular frame RL is displayed to be overlaid on the page in the screen. Further, in the page pilot mode, a part of the screen other than the area (hereafter, referred to as “designated area RL′” for the sake of convenience) surrounded by the rectangular frame RL is provided with an image effect such as hatching. Consequently, the designated area RU is displayed in a highlighted state. On four corners of the designated area RL′, arrows A₁ to A₄ are displayed. At the center of the designated area RL′, a cursor C is displayed. The initial size of the rectangular area RL displayed at the time of transition to the page pilot mode can be changed desirably, for example, through the user operation.

The shape of the cursor C represents the 5-way key. When the user operates the four direction keys in the state of FIG. 5(b), the rectangular frame RL moves on the page in response to the operation, for example, as shown in FIG. 5(c). In FIG. 5(c), part of text in the page is included in the designated area RL′.

The terminal device 10 may be a device which can be operated by a known stylus pen. In this case, for example, when the user moves the stylus pen on the page while selecting the cursor C by the stylus pen (i.e., when the user drags the cursor C), the rectangular area RL moves on the page in accordance with movement of the pen. Further, when the user drags one of the arrows A₁ to A₄, the size of the rectangular frame RL changes. For example, when the user drags the arrow A3 toward the lower right part of the screen with the stylus pen, the rectangular frame RL expands in the right and lower directions.

When the page is displayed in the normal display form in the page pilot mode, the browser 50 stores data concerning the position of each element contained in the page being displayed and the position of the rectangular frame RL. That is, through the analysis result of the browser engine 30, the browser engine 30 obtains the position information of each element defined on a basis of a predetermined index, not on a basis of a unit of an element defined by a tag of a markup language. As a matter of course, the browser 50 stores position information of the rectangular frame RL.

When the page is displayed in the capturing display form in the page pilot mode, the position of each element in the captured image and the position of the rectangular frame RL are known by the browser 50. This is because the captured image is displayed in the same scale as that of the page in the normal display form, and the browser 50 is able to recognize the position of each element in the captured image based on the analysis result of the captured image by the browser engine 30. It should be noted that even when the captured image is displayed in a scale different from a scale of the page in the normal display form, the browser 50 is able to recognize the position of each element in the captured image based on the analysis result of the captured image and the information concerning the scale of the captured image as long as the browser 50 stores the information concerning the scale of the captured image. Furthermore, when the browser 50 creates the captured image from the data of the page, the browser 50 may obtain and store in advance the position information of each element in the captured image based on the analysis result. If the captured image is displayed in the scale different from the scale of the normal display form, the browser 50 is able to recognize the position of each element in the captured image based on the information concerning the scale and the position information obtained in advance as in the case of the above described example.

When the enter key 113E is pressed in the state shown in FIG. 5(c) (or when the cursor C is double-clicked, for example, with the stylus pen when the stylus pen is used), the browser 50 judges that the designated area RL′ is confirmed, and detects which portion is surrounded by the designated area RL′ (S2). Next, the browser 50 executes an extraction process (which is described later) for extracting elements included in the designated area RL′ (S3). Then, the browser 50 changes the display mode to the simple view mode shown in FIG. 5(d) using each extracted element (S4), and terminates the process of the flowchart.

Hereafter, processes in S3 and S4 are explained in detail. In the simple view mode presented through the process of S4, text or an image at least a part of which is included in the designated area RL′ in the page pilot mode is extracted and is rendered again (i.e., each element extracted in the process of S3 is rendered again). In the process of S3, text is extracted on a basis of a sentence or a paragraph delimited by the above described predetermined indexes, and an image is extracted on a basis of one image. The display scale of each element in the simple view mode is a preset scale, and is higher that the display scale in the normal display form or the capturing display form. Furthermore, the scale can be changed, for example, through the user operation. If the number of extracted elements is large, a possibility that all of the extracted elements are not accommodated in the screen in the simple view mode arises. In such a case, a scroll bar SB₃ is displayed at an edge part of the screen as shown in FIG. 5(d). The user is able to browse all of the extracted elements by scrolling the screen of the simple view mode by operating the scroll bar SB₃. If the number of extracted elements is large, the browser 50 may automatically adjust the scale such that all of the elements are accommodated in the screen.

When moving to the simple view mode, the browser 50 executes the process of S2 first, and detects which part in the page is surrounded by the designated area RL′. Then, the browser 50 executes the process of S3 to identify text (or part of text) included in the designated area RL′. Then, the browser 50 detects positions of indexes (e.g., punctuations, linefeed codes, predetermined tags and etc.) before and after the identified text (hereafter, referred to as “the text in the designated area”). Based on the position of the predetermined indexes, the browser 50 extract the entire one sentence (or the entire one phrase, the entire one paragraph) including the text in the designated area. For example, if the browser is set to extract the entire one sentence, the browser 50 detects positions of punctuations (or periods) before and after the text in the designated area. Then, the browser 50 executes the process of S4 to render the extracted text again and to display the extracted text in the simple view mode. These processes are executed for all the text in the designated area.

Furthermore, when the browser 50 detects which portion is surrounded by the designated area RL′ by executing the process of S2, the browser 50 also executes the process of S3 for the image contained in the designated area RL′. The browser 50 identifies the image which is judged that at least a part thereof is included in the designated area RL′, and extracts the entire image (i.e., one image file). Then, the browser 50 executes the process of S4 to render the extracted image again and to display the rendered image in the simple view mode. These processes are executed for all the images included in the designated area RL′.

When the function key F₂ is pressed by the user, the browser 50 returns from the simple view mode to the page pilot mode.

As described above, according to the embodiment, there is no necessity for the user to execute precisely a designating operation for designating an area including all of desired elements when the user extracts all the desired elements. The user is able to extract all the elements, to enlarge and display all the elements, and to browse all the elements through a simple operation of designating an area including at least a part of the desired element. In other words, by only performing a user operation of roughly designating the designated area RL′ to include at least a part of the desired element, the user is able to enlarge and display the all the elements and to browse the elements in a high degree of visibility. Since occurrence of a problem that a part of the desired element is cut away in an enlarged display (which might be caused in a conventional system) can be prevented, the need for performing a troublesome operation for designating an area again can be eliminated. Such enhancement in operability is considerably useful for users who frequently browse pages.

Furthermore, according to the embodiment, the user is not required to designate an area to include all the desired elements. Therefore, the user does not need to expand the rectangular area RL wastefully. As a result, a possibility that undesired elements are included in the designated area RL′ decreases. In this point of view, the user becomes able to easily extract only desired elements, to enlarge and display the elements, and to browse the elements.

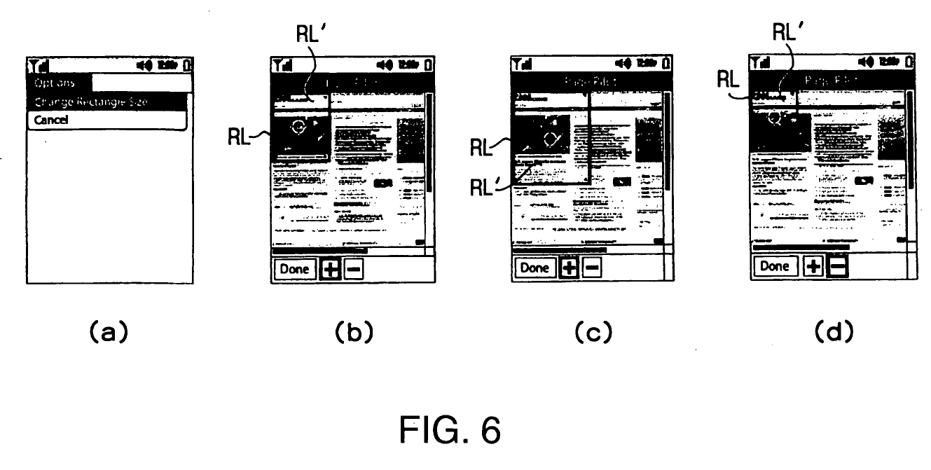

Next, an example of the screen display by the browser 50 according to the embodiment is shown in FIGS. 6(a) to 6(d). When the function key F1 is pressed in the state shown in FIG. 4(b) or (c), the onscreen representation shown in FIG. 6(a) is presented on the display 111. When the “Change Rectangle Size” in the menu “Option” is selected through the user operation, icons “+” and “−” are displayed as shown in FIG. 6(b). In this embodiment, when the left direction key 113L of the 5-way key is pressed, the icon “+” is selected, and the size of the rectangular frame RL increases step by step in accordance with the number of selections of the icon “+” (see for example FIG. 6(c)). Similarly, when the right direction key 113R of the 5-way key is pressed, the icon “−” is selected, and the size of the rectangular frame RL decreases step by step in accordance with the number of selections of the icon “−” (see for example FIG. 6(d)). When the user wants to browse a large number of elements in an enlarged display, the user may press the left direction key 113L corresponding to the “+” icon. When the user wants to browse a limited number of elements in an enlarged display, the user may press the right direction key 113R corresponding to the “−” icon. When the stylus pen is used, the user is able to change the size of the rectangular frame RL by touching the icon “+” or the icon “−” displayed on the display with the stylus pen.

The embodiment according to the invention has been described. The present invention is not limited to the above described embodiment, and various types of variations can be made within the scope of the concept of the present invention. For example, although in the above described embodiment, a page is targeted for the processes, an electronic document in a PDF (Portable Document Format) may be targeted for the processes in another embodiment.

In the above described embodiment, the onscreen representation is switched between the page pilot mode and the simple view mode. However, in another embodiment, extracted elements (i.e., elements to be displayed in the simple view mode) may be displayed in an enlarged state in the designated area RL′. That is, in this case, the extracted elements are rendered to be accommodated in another window (i.e., the designated area RL′), and the elements are displayed in an enlarged state. Since the page in the normal display form (or a captured image) is displayed in the background of another window, the user is able to browse the desired elements in a high degree of visibility while recognizing the content of the entire page. It should be noted that the size of another window can be changed, for example, through a user operation. Furthermore, when the number of extracted elements is large, another window may be made in a form where scrolling can be performed so that all the extracted elements can be browsed. Furthermore, the browser may operate to automatically adjust the scale so that all the elements are accommodated in another window.

In another embodiment, a two-way split may be adopted to display content in the page pilot mode in one divided screen, and display an enlarged image in the simple view mode in the other divided screen.

In the above described embodiment, all the elements (text, images, etc.) included in the designated area RL′ are enlarged and displayed. However, in another embodiment, only a part of elements extracted based on a predetermined rule may be displayed in an enlarged display in the simple view mode. For example, the predetermined rule includes the following items (1) to (6). Whether to enlarge and display all the elements included in the designated area RL′ in the simple view mode without considering the predetermined rules listed below as in the case of the above described embodiment, or to enlarge and display only a part of the elements in accordance with one of the rules listed below may be selected, for example, through a user operation.

(1) Only text (or only images) is extracted from elements included in the designated area RL′.
(2) Only text whose number of letters is larger than or equal to a predetermined number (or smaller than a predetermined number) is extracted from elements included in the designated area RL′.
(3) A predetermined number of elements (at least one element) are extracted from elements included in the designated area RL′ in decreasing order of area defined at the time of display, and are enlarged and displayed.
(4) Weighting is executed for each of element types so that, for example, the higher priority is assigned to text (or images). Then, a predetermined number of elements (at least one element) are extracted from the elements included in the designated area RL′ in accordance with the defined priorities, and are enlarged and displayed.
(5) Regarding an element which is regarded as being entirely included in the designated area RL′ as a result of comparison between the position information of the rectangular area RL and the position information of the elements, the entire element is extracted, and is enlarged and displayed. Furthermore, regarding an element which is determined that only a part thereof is included in the designated area RL′, the browser 50 judges that the user intentionally designates only a part of the element, and extracts only the part of the element included in the designated area RL′ to enlarge and display the part of the element.
(6) Which of elements user wants to execute browsing is predicted by referring to a part of each element included in the designated area RL′. For example, when a starting part of text and a lower right part of an image are included in the designated area RL′, the browser 50 judges that the text is the element which the user wants to browse. Then, the browser 50 extracts only the text to enlarge and display the text, and does not display the image. For example, if a starting part of text and an end part of another text are included in the designated area RL′, the browser 50 judges that the former text is the element which the user wants to browse. Then, the browser 50 only extracts the former text, and enlarges and displays the text.

Some of various types of mobile phones are provided with two screens. Regarding such a mobile phone, a page may be displayed on one screen in the page pilot mode, and the enlarged onscreen representation in the simple view mode may be made on the other screen.

In the above described embodiment, the page pilot mode is intended for a single page. However, in another embodiment, a plurality of pages may be displayed in the page pilot mode as thumbnail images. Each image displayed as a thumbnail is a captured image which has been browsed in the past. By storing the position information of each element when the captured image is stored and by designating a desired area of the captured image displayed as a thumbnail, the user is able to browse the enlarged view of the element included in the area in the simple view mode as in the case of the above described embodiment.

1. A terminal device adapted to display content, comprising:
a display;
a content display unit that analyzes data of the content, and renders and displays the content on the display based on a result of analyzing;
an area designation unit that designates an area in the content displayed on the display;
an element extraction unit that extracts an element which forms the content and at least a part of which is included in the designated area; and
a content enlarging and displaying unit that enlarges the extracted element relative to a size defined when the area is designated and displays the extracted element on the display,
wherein the content enlarging and displaying unit renders the extracted element again and displays the extracted element on the display.

2. (canceled)

3. The terminal device according to claim 1, wherein the element is identified on a basis of a predetermined character string or code.

4. The terminal device according to claim 3, wherein the predetermined character string or code includes at least one of a tag of a markup language and a punctuation or a control code.

5. The terminal device according to claim 4, wherein the control code includes at least one of a page break, a linefeed or a tab.

6. The terminal device according to claim 1,
further comprising:
an operation unit that accepts an input operation by a user; and
a designated area setting unit that sets a position of the area designated by the area designation unit in accordance with the input operation.

7. The terminal device according to claim 6, further comprising a designated area size setting unit that sets a size of the area designated by the area designation unit in accordance with the input operation.

8. The terminal device according to claim 1,
further comprising:
a captured image creation unit that creates a captured image of the content; and
a position relationship information creation unit that creates position relationship information for associating a position of the captured image with a position of the content,
wherein:
the content display unit displays the content on the display by displaying the captured image of the content; and
the area designation unit designates an area in the captured image of the content displayed on the display to designate the area of the content corresponding to the designated area of the captured image based on the position relationship information.

9. The terminal device according to claim 1, wherein the content display unit highlights and displays the area designated by the area designation unit.

10. The terminal device according to claim 1, wherein the element extraction unit executes extraction of an element, further based on a predetermined rule, from elements at least a part of each of which is included in the designated area of the content.

11. The terminal device according to claim 1,
wherein:
the terminal device comprises two displays;
the content display unit displays the content on one of the two displays, and the content enlarging and displaying unit displays the element extracted by the element extraction unit on the other of the two displays such that the extracted element is enlarged relative to the one of the two displays.

12. A content display method for displaying content on a display, comprising:
a content display step of analyzing data of the content, and rendering and displaying the content on the display based on a result of analyzing;
an area designation step of designating an area in the content displayed on the display;
an element extraction step of extracting an element which forms the content and at least a part of which is included in the designated area; and
an enlarging and displaying step of enlarging the extracted element relative to a size defined when the area is designated and displaying the extracted element on the display,
wherein in the content enlarging and displaying step, the extracted element is rendered again and is displayed on the display.

13. (canceled)

14. The content display method according to claim 12, wherein the element is identified on a basis of a predetermined character string or code.

15. The content display method according to claim 14, wherein the predetermined character string or code includes at least one of a tag of a markup language and a punctuation or a control code.

16. The content display method according to claim 15, wherein the control code includes at least one of a page break, a linefeed or a tab.

17. The content display method according to claim 12,
further comprising:
an operation step of accepting an input operation by a user; and
a designated area setting step of setting a position of the area designated in the area designation step in accordance with the input operation.

18. The content display method according to claim 12, further comprising a designated area size setting step of setting a size of the area designated in the area designation step in accordance with the input operation.

19. The content display method according to claim 12,
further comprising:
a captured image creation step of creating a captured image of the content; and
a position relationship information creation step of creating position relationship information for associating a position of the captured image with a position of the content,
wherein:
the content display step displays the content on the display by displaying the captured image of the content; and
the area designation step designates an area in the captured image of the content displayed on the display to designate the area of the content corresponding to the designated area of the captured image based on the position relationship information.

20. The content display method according to claim 12, wherein the content display step highlights and displays the area designated in the area designation step.

21. The content display method according to claim 12, wherein the element extraction step executes extraction of an element, further based on a predetermined rule, from elements at least a part of each of which is included in the designated area of the content.

22-23. (canceled)

24. The content display method according to claim 21,
wherein the predetermined rule includes at least one of following rules:
(1) only text or images is extracted from elements included in the designated area;
(2) only text whose number of letters is larger than or equal to a predetermined number or only text whose number of letters is smaller than a predetermined number is extracted from elements included in the designated area;
(3) a predetermined number of elements are extracted from elements included in the designated area in decreasing order of area defined at a time of display;
(4) by executing weighting for each of element types and defining a priority for each of the element types, a predetermined number of elements are extracted from the elements included in the designated area in accordance with the defined priorities; and
(5) which of elements a user wants to execute browsing is predicted by referring to a part of each element included in the designated area, and elements are extracted based on a prediction result.

25. The content display method according to claim 24,
wherein the predetermined rule further includes a rule:
(6) regarding an element which is regarded as being entirely included in the designated area as a result of comparison between position information of the designated area and position information of the element included in the designated area, the entire element is extracted, and regarding an element which is determined that only a part thereof is included in the designated area, it is judged that a user intentionally designates only a part of the element, and only the part of the element included in the designated area is extracted.

26. A computer readable medium having computer readable instruction stored thereon, which, when executed by a processor of a device, configures the processor to perform the steps of:
a content display step of analyzing data of content, and rendering and displaying the content on a display based on a result of analyzing;
an area designation step of designating an area in the content displayed on the display;
an element extraction step of extracting an element which forms the content and at least a part of which is included in the designated area; and
an enlarging and displaying step of enlarging the extracted element relative to a size defined when the area is designated and displaying the extracted element on the display,
wherein in the content enlarging and displaying step, the extracted element is rendered again and is displayed on the display.

27. The computer readable medium according to claim 26, wherein the element is identified on a basis of a predetermined character string or code.

28. The computer readable medium according to claim 27, wherein the predetermined character string or code includes at least one of a tag of a markup language and a punctuation or a control code.

29. The computer readable medium according to claim 28, wherein the control code includes at least one of a page break, a linefeed or a tab.

30. The computer readable medium according to claim 26,
wherein the instruction further causes the processor to perform the steps of:
an operation step of accepting an input operation by a user; and
a designated area setting step of setting a position of the area designated in the area designation step in accordance with the input operation.

31. The computer readable medium according to claim 26, wherein the instruction further causes the processor to perform a designated area size setting step of setting a size of the area designated in the area designation step in accordance with the input operation.

32. The computer readable medium according to claim 26, wherein the instruction further causes the processor to perform the steps of:
a captured image creation step of creating a captured image of the content; and
a position relationship information creation step of creating position relationship information for associating a position of the captured image with a position of the content,
wherein:
the content display step displays the content on the display by displaying the captured image of the content; and
the area designation step designates an area in the captured image of the content displayed on the display to designate the area of the content corresponding to the

33. The computer readable medium according to claim 26, wherein the content display step highlights and displays the area designated in the area designation step.

34. The computer readable medium according to claim 26, wherein the element extraction step executes extraction of an element, further based on a predetermined rule, from elements at least a part of each of which is included in the designated area of the content.

35. The computer readable medium according to claim 34,
wherein the predetermined rule includes at least one of following rules:
(1) only text or images is extracted from elements included in the designated area;
(2) only text whose number of letters is larger than or equal to a predetermined number or only text whose number of letters is smaller than a predetermined number is extracted from elements included in the designated area;
(3) a predetermined number of elements are extracted from elements included in the designated area in decreasing order of area defined at a time of display;
(4) by executing weighting for each of element types and defining a priority for each of the element types, a predetermined number of elements are extracted from the elements included in the designated area in accordance with the defined priorities; and
(5) which of elements a user wants to execute browsing is predicted by referring to a part of each element included in the designated area, and elements are extracted based on a prediction result.

36. The computer readable medium according to claim 35,
wherein the predetermined rule further includes a rule:
(6) regarding an element which is regarded as being entirely included in the designated area as a result of comparison between position information of the designated area and position information of the element included in the designated area, the entire element is extracted, and regarding an element which is determined that only a part thereof is included in the designated area, it is judged that a user intentionally designates only a part of the element, and only the part of the element included in the designated area is extracted.

37. The terminal device according to claim 10,
wherein the predetermined rule includes at least one of following rules:
(1) only text or images is extracted from elements included in the designated area;
(2) only text whose number of letters is larger than or equal to a predetermined number or only text whose number of letters is smaller than a predetermined number is extracted from elements included in the designated area;
(3) a predetermined number of elements are extracted from elements included in the designated area in decreasing order of area defined at a time of display;
(4) by executing weighting for each of element types and defining a priority for each of the element types, a predetermined number of elements are extracted from the elements included in the designated area in accordance with the defined priorities; and
(5) which of elements a user wants to execute browsing is predicted by referring to a part of each element included in the designated area, and elements are extracted based on a prediction result.

38. The terminal device according to claim 37,
wherein the predetermined rule further includes a rule:
(6) regarding an element which is regarded as being entirely included in the designated area as a result of comparison between position information of the designated area and position information of the element included in the designated area, the entire element is extracted, and regarding an element which is determined that only a part thereof is included in the designated area, it is judged that a user intentionally designates only a part of the element, and only the part of the element included in the designated area is extracted.

39. The terminal device according to claim 1, wherein the content enlarging and displaying unit displays the extracted element in a first displaying mode different from a second displaying mode in which the content is displayed by the content display unit.
